(19) United States
(12) Patent Application Publication
(10) Pub. No.: US 2024/0320066 A1
(43) Pub. Date: Sep. 26, 2024

(54) Multi-Access Edge Computing (MEC) Application Instance Registration

(71) Applicant: Apple Inc., Cupertino, CA (US)

(72) Inventors: Walter Featherstone, Cirencester (GB); Haijing Hu, Los Gatos, CA (US); Mona Agnel, Guildford (GB); Shu Guo, Beijing (CN); Sudeep Manithara Vamanan, Uttenreuth (DE)

(21) Appl. No.: 18/605,085

(22) Filed: Mar. 14, 2024

(30) Foreign Application Priority Data
Mar. 23, 2023 (WO) PCT/CN2023/083305

(51) Int. Cl. G06F 9/54

(52) U.S. Cl. CPC G06F 9/542

(57) ABSTRACT

The present application relates to improved methods of application instance registration in a Multi-access Edge Computing (MEC) system, comprising, e.g.: receiving, at a MEC platform device, a registration request for a first application instance; determining, by the MEC platform device, that the first application instance is not presently registered; in response to determining that the first application instance is not presently registered, allocating, by the MEC platform device, a first application instance registration identifier for the first application instance; transmitting, by the MEC platform device, the first application instance registration identifier to the first application instance; and causing, by the MEC platform device, a first application instance registration notification to be sent to a MEC system-level management device. According to some aspects, the MEC platform device may first send a permission request to a MEC system-level management device to request permission to be able to register the first application instance.

### TECHNICAL FIELD

The present application relates to wireless devices and wireless networks, including user devices, terminals, circuits, computer-readable media, and methods for improved application instance registration among edge computing resources in a cellular network system.

### BACKGROUND

Wireless communication systems are rapidly growing in usage. In recent years, wireless devices such as smart phones and tablet computers have become increasingly sophisticated. In addition to supporting telephone calls, many mobile devices now provide access to the Internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), Long-Term Evolution (LTE), LTE Advanced (LTE-A), HSPA, 3GPP2 CDMA2000 (e.g., 1×RTT, 1×EV-DO, HRPD, eHRPD), IEEE 802.11 (WLAN or Wi-Fi), and BLUETOOTH™, among others.

Despite the rapid technological evolution of mobile user equipment (UEs), computationally demanding applications on a smartphone or tablet are still constrained by limited battery capacity, thermal limits and device size and cost considerations. To overcome this problem, computationally complex processing can be offloaded to centralized servers, i.e., to the cloud. For example, Mobile Cloud Computing (MCC) refers to servers that provide cloud computing resources for mobile users. However, the use of MCC may introduce significant communication delay. Such a delay is inconvenient and makes computational offloading unsuitable for real-time applications.

To solve this problem, the cloud service has been physically moved closer to users, i.e., toward the “edge” of the network. The concept of Multi-access Edge Computing (MEC), also referred to as “Mobile Edge Computing” or simply “Edge Computing,” refers to an evolution of cloud computing that brings application hosting from centralized data centers down to the “network edge,” i.e., physically closer to consumers and the data generated by applications. Edge computing is acknowledged as one of the key components for meeting the performance demands of modern cellular networks, such as 5G networks, especially with respect to reducing latency and improving bandwidth efficiency.

However, improvements in the MEC field are desired, especially with respect to the management of applications and their respective instances.

### SUMMARY

In accordance with one or more embodiments, a method of application instance registration in a Multi-access Edge Computing (MEC) system is disclosed, the method comprising: receiving, at a MEC platform device, a registration request for a first application instance; determining, by the MEC platform device, that the first application instance is not presently registered; in response to determining that the first application instance is not presently registered, allocating, by the MEC platform device, a first application instance registration identifier for the first application instance; transmitting, by the MEC platform device, the first application instance registration identifier to the first application instance; and causing, by the MEC platform device, a first application instance registration notification to be sent to a MEC system-level management device.

According to some aspects, the MEC platform device may be communicatively coupled to a MEC platform manager device, e.g., via an interface, such as an Mm5 reference point.

According to other aspects, determining that the first application instance is not presently registered further comprises: determining, by the MEC system-level management device, that the first application instance is not presently registered by the MEC system.

According to some aspects, the registration request for the first application instance comprises at least one identifier uniquely identifying the first application instance (e.g., in the case of EDGEAPP, the identifier may comprise an EASID+endpoint identifier, while, in ETSI MEC, the identifier may comprise an appName+endpoint identifier).

According to other aspects, determining that the first application instance is not presently registered further comprises: determining that the first application instance is not presently registered by a management and orchestration (MANO) system of the MEC system.

According to some aspects, the first application instance registration notification comprises at least the first application instance registration identifier, wherein, e.g., the first application instance registration notification may comprise at least one or more additional application information fields associated with the first application instance (e.g., an AppInfo record, in some cases).

In accordance with one or more other embodiments, another method of application instance registration in a multi-access edge computing (MEC) system is disclosed, the method comprising: receiving, at a MEC platform device, a registration request for a first application instance; determining, by the MEC platform device, that the first application instance is not presently registered; in response to determining that the first application instance is not presently registered, causing, by the MEC platform device, a first permission request to be sent to a MEC system-level management device, wherein the first permission request is configured to request permission from the MEC system-level management device for the MEC platform device to be permitted to register the first application instance; receiving, at the MEC platform device, an indication that the first permission request has been granted; in response to receiving the indication that the first permission request has been granted, allocating, by the MEC platform device, a first application instance registration identifier for the first application instance; transmitting, by the MEC platform device, the first application instance registration identifier to the first application instance; and causing, by the MEC platform device, a first application instance registration notification (e.g., including at least the first application instance registration identifier and/or one or more additional application information fields associated with the first application instance) to be sent to the MEC system-level management device.

According to some aspects, determining that the first application instance is not presently registered further comprises: determining, by the MEC system-level management device, that the first application instance is not presently registered by the MEC system.

According to other aspects, the registration request for the first application instance comprises at least one identifier uniquely identifying the first application instance (e.g., in the case of EDGEAPP, the identifier may comprise an EASID+endpoint identifier, while, in ETSI MEC, the identifier may comprise an appName+endpoint identifier).

According to still other aspects, the requesting of permission from the MEC system-level management device for the MEC platform device to be permitted to register the first application instance further comprises: causing, at the MEC system-level management device, any services or features required by the first application instance to be made available at the MEC platform device. According to yet other aspects, the first application instance registration notification causes the MEC system-level management device to: make available, at the MEC platform device, any services or features that are optional or required by the first application instance.

According to some aspects, the method further comprises causing the first permission request to be sent from the MEC system-level management device to an operator-level support device of the MEC system, wherein the MEC system-level management device is further configured to request permission from the operator-level support device for the MEC platform device to be permitted to register the first application instance. According to other aspects, the first application instance registration notification is further caused to be sent to an operator-level support device.

According to still other aspects, the first application instance registration identifier is allocated by the MEC platform device before the MEC platform device causes the first permission request to be sent to the MEC system-level management device.

The various methods and techniques summarized in this section may likewise be performed by a device comprising: a receiver; a transmitter; at least one interface; and a processor configured to perform any of the various methods and techniques summarized herein. The various methods and techniques summarized in this section may likewise be stored as instructions in a non-transitory computer-readable medium, wherein the instructions, when executed, cause the performance of the various methods and techniques summarized herein.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates another example of a wireless communication system, according to some aspects.

FIG. 3 illustrates an example block diagram of a UE, according to some aspects.

FIG. 4 illustrates an example block diagram of a Base Station (BS), according to some aspects.

FIG. 5A illustrates the exemplary European Telecommunications Standards Institute (ETSI) MEC architecture.

FIG. 5B illustrates the exemplary Third Generation Partnership Project (3GPP) EDGEAPP architecture.

FIG. 6A illustrates a diagram detailing a method of MEC application instance registration, according to some aspects.

FIG. 6B illustrates a diagram detailing a method of MEC application instance registration that includes a granting procedure in order to allow an application instance to successfully register, according to some aspects.

FIG. 7A is a flowchart detailing a method of performing MEC application instance registration, according to some aspects.

FIG. 7B is a flowchart detailing a method of performing MEC application instance registration that includes a granting procedure in order to allow an application instance to successfully register, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The present application relates to Multi-access Edge Computing (MEC) systems. Modern cellular phones are being asked to perform increasingly complex applications. In general, users prefer the use of smartphones (e.g., UEs) due to their portability, size and ease of use. However, being portable or mobile devices, UEs, such as smartphones, are battery-powered and have a small size relative to non-portable devices such as desktop computers. Thus, UE devices have various hardware limitations, such as battery life, power, processing ability and memory capacity.

In order to reduce the load of applications running on UE devices, and also to provide for more efficient use of UE resources, efforts have been made to offload the computational requirements of the UE to another computing resource. As mentioned above, the term “Mobile Cloud Computing” (MCC) refers to the use of cloud servers to perform computational tasks that may otherwise be performed by a UE. However, as described above, the use of cloud servers that are physically remotely located from the UEs they are attempting to assist (the UEs from which they are attempting to offload tasks) may introduce communication delays that make such cloud servers unsuitable for real time applications.

MEC provides an information technology (IT) service environment and cloud computing capability at the edge of the mobile network, within the Radio Access Network (RAN) and in close physical proximity to mobile subscribers. In other words, MEC operates to locate mobile cloud computing (MCC) services physically closer to mobile users, or physically closer to the cellular base stations that serve the UEs (i.e., closer to the “edge” of the network), to reduce communication delays. Specific user requests may thus be managed directly at the network edge, instead of forwarding all traffic to remote Internet services that are a further distance away. MEC promises significant reduction in latency and mobile energy consumption while delivering exceptionally reliable and sophisticated services.

In a MEC system as described herein, a MEC application instance registration task may be performed by a MEC platform (MEP) device. For applications managed by the MEC system's management and orchestration system (also referred to as “MANO”) an application instance identifier is assigned during the instantiation procedures (e.g., as defined in ETSI GS MEC 010-2).

However, for application instances that are not managed by the MEC MANO, there is a need for novel methods and techniques to make the MEC MANO aware of such “non-MEC MANO-managed” application instances, e.g., when such an instance makes a registration request. Such techniques may enable inter-MEC system application instance discovery. Such discovery processes may also enable the sharing of the application info data type (e.g., of the AppInfo data type), although access to certain attributes of that data type may still potentially be restricted, e.g., based on permission levels and/or the MEC system's service provider policy.

The following is a glossary of additional terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “Terminal”) —any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, PlayStation Vita™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor) —refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

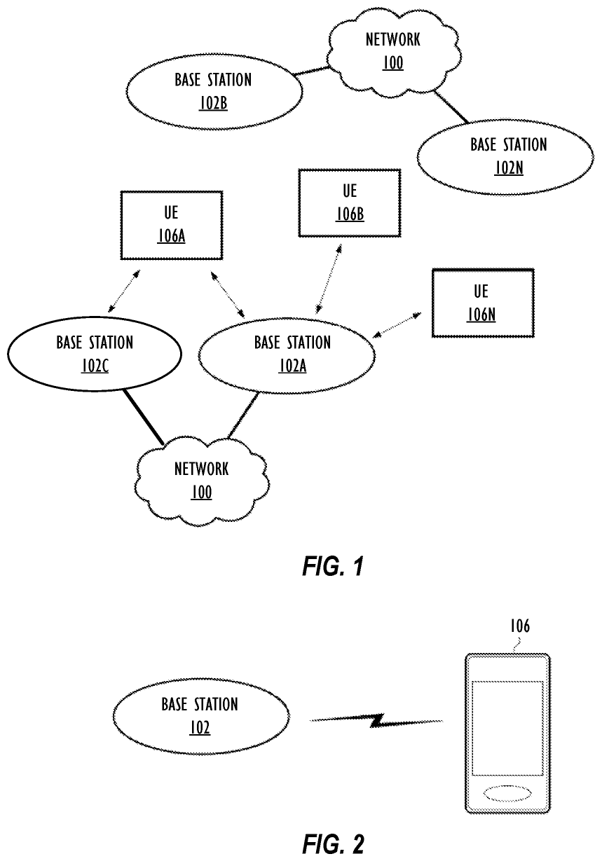

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHZ Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

As illustrated in FIG. 2, in one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

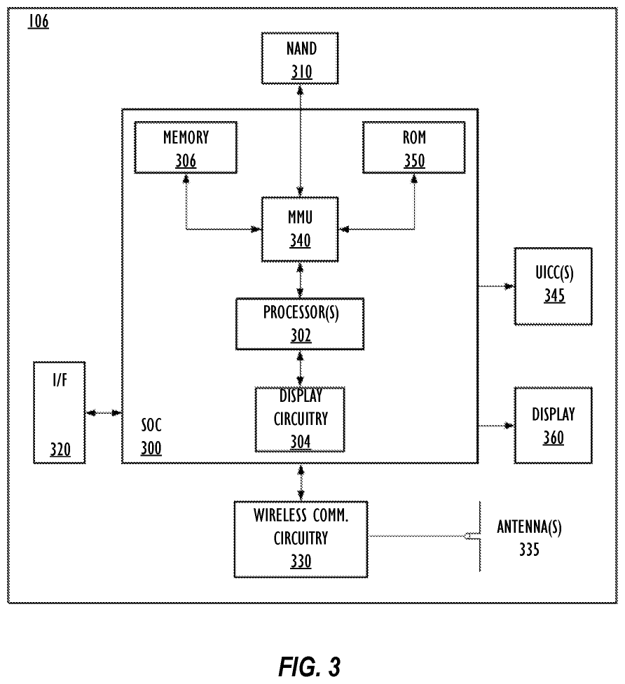

FIG. 3 illustrates an example simplified block diagram of a communication device 106, according to some aspects. It is noted that the block diagram of the communication device of FIG. 3 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components configured to perform core functions. For example, this set of components may be implemented as a system on chip (SOC), which may include portions for various purposes. Alternatively, this set of components may be implemented as separate components or groups of components for the various purposes. The set of components may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 345 that include Subscriber Identity Module (SIM) functionality, such as one or more Universal Integrated Circuit Card(s) (UICC(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

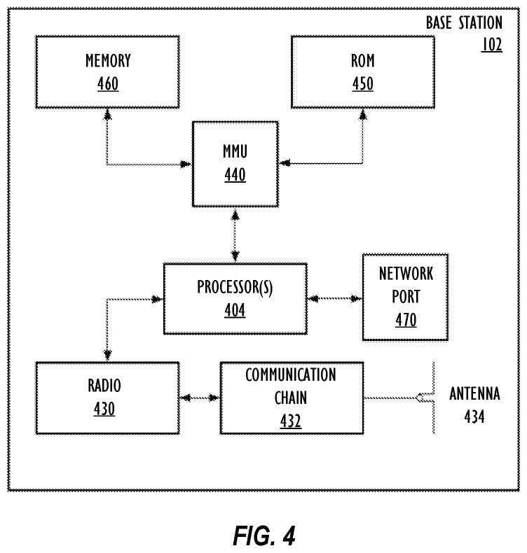

FIG. 4 illustrates an example block diagram of a base station 102, according to some aspects. It is noted that the base station of FIG. 4 is a non-limiting example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

### ETSI MEC Architecture

The MEC initiative is an Industry Specification Group (ISG) within the European Telecommunications Standards Institute (ETSI), whose purpose is to create a standardized, open environment that allows for an efficient and seamless integration of applications from vendors, service providers, and third parties across multi-vendor Multi-access Edge Computing (MEC) platforms. ETSI MEC provides set of standards, specifications, and API definitions that help enable various edge service models across the different types of edge deployments.

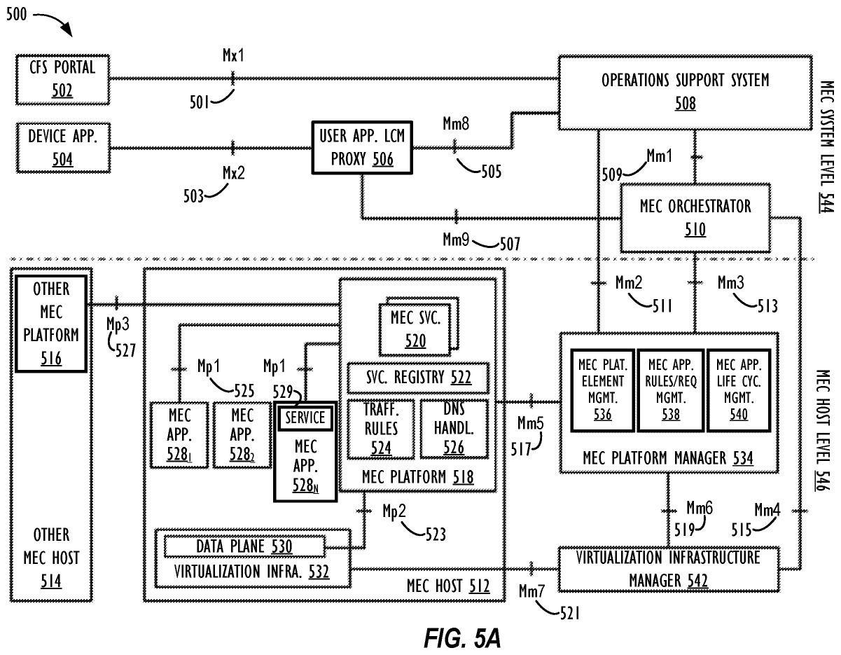

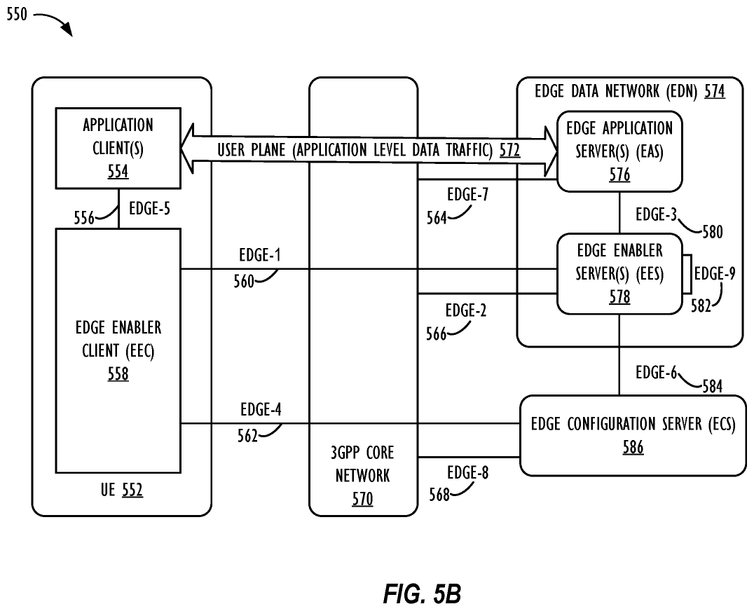

Turning now to FIG. 5A, the exemplary ETSI MEC architecture 500 is illustrated. Starting with the top half of FIG. 5A, the MEC system level 544 components will be described. First, a customer facing service (CFS) Portal 502 may connect via an Mx1 (501) reference point to an Operations Support System (OSS) 508 (also referred to, in some implementations, as a Business Support System (BSS)). OSS and BSS, in telecommunications, refers to operations support system and business support system, respectively, which have to do with maintaining a customer's operations and business functions, as opposed to that of the network itself. Similarly, a device application 504 may connect via an Mx2 (503) reference point to a user application life cycle management (LCM) proxy 506. Mx reference points relate to external entities, such as OSS and other customer-facing service portals or LCM proxies.

The user application life cycle management proxy 506 may connect via an Mm8 (505) reference point to Operations Support System 508 and via an Mm9 (507) reference point to MEC Orchestrator 510. MEC Orchestrator 510 is responsible for system level management within a MEC deployment. The MEC Orchestrator 510 may be responsible for, e.g.: maintaining an overall view of the MEC system based on available resources, services, and topologies; onboarding application packages by adhering to set of operator policies; selecting MEC hosts for instantiating applications based on set constraints; and/or application creation, relocation, and termination. Mm reference points are related to MEC management entities, such as the MEC Orchestrator 510, Operation System Support (OSS) 508, MEC platform manager (MEPM) 534, etc. The Operations Support System 508 and MEC Orchestrator 510 may themselves be connected via an Mm1 (509) reference point.

Turning now to the bottom half of FIG. 5A, the MEC host level 546 components will be described. The MEC host level 546 may comprise a MEC platform manager 534 for managing the entire MEC host platform. The MEC platform manager 534 is one of the main system components used to manage the lifecycle of applications by managing traffic rules, DNS configuration, service authorizations, etc. The MEC platform manager 534 may connect via an Mm2 (511) reference point to Operations Support System 508 and via an Mm3 (513) reference point to MEC Orchestrator 510. The MEC platform manager 534 may comprise various components, such as: the MEC platform element manager 536; the MEC application rules/requirement modules 538; and the MEC application life cycle management (LCM) module 540.

The MEC platform manager 534 may also connect via an Mm5 (517) reference point to one or more MEC platforms, e.g., MEC platform 518. A MEC platform (e.g., 518) is an entity that may be contained within a MEC host 512, where the MEC host 512 also contains a virtualization infrastructure 532, which provides compute, storage, and network resources for the MEC applications. The host infrastructure provides all the necessary components to operate in an Edge Cloud environment.

The MEC platform 518 may provide a broad set of functions within a MEC host 512 that enables MEC Apps 528 to be operational within a MEC deployment. MEC platform 518 responsibilities include, e.g.: DNS handling (e.g., between MEC platform manager 534 and MEC Apps 528); provides access to persistent storage and time of day information; providing an environment for MEC Apps 528 to discover, advertise, consume and offer MEC services 529; and receiving traffic rules from MEC platform manager 534, applications, or services, and then instructs data plane 530, accordingly.

The MEC platform 518 may comprise, e.g.: MEC services 520; a service registry 522, traffic rules control module 524, and DNS handler 526. Each MEC platform 518 may be connected via an Mp1 (525) reference point to one or more MEC apps (528n). A MEC app may be thought of as an application that runs as a Virtual Machine (VM) within in a MEC host (e.g., 512) to provide MEC services and interact with MEC Platform (e.g., 518). There may be predefined rules and requirements to adhere to in Edge computing environments, such as resource constraints, latency limits, and the like. Each MEC app 528 may offer (or consume) services 529, which are exposed as APIs (or they can also be a standalone app and not produce, or need to consume, any services). Service offering may include, e.g., providing radio network information, location services, or bandwidth management services, etc. Information regarding the available services can be obtained from the MEC platform 518. The MEC platform 518 may also be connected via an Mp2 (523) reference point to a virtualization infrastructure 532, which includes access to data plane 530. Mp references are related to MEC platform entities and provide the interaction requirements between and among MEC applications or multiple MEC platforms.

MEC host 512 may be connected to other MEC hosts (e.g., 514) via an Mp3 (527) reference point, wherein each MEC host 514 may have its own MEC platform 516 (i.e., containing similar components to those described above with reference to MEC platform 518).

In some implementations, the MEC platform manager 534 and MEC hosts 512 may be managed by a virtualization infrastructure manager 542. Virtualization infrastructure manager 542 may be connected to: other MEC hosts (e.g., 512) via an Mm7 (521) reference point; the MEC platform manager 534 via an Mm6 (519) reference point; and the MEC Orchestrator 510 via an Mm4 (515) reference point.

### EDGEAPP: 3GPP Architecture for Enabling Edge Applications

As described above, the deployment of edge computing involves establishing relationships between multiple providers. Edge Computing Service Providers (ECSP) will play an important role in the construction of the infrastructure used by the Mobile Network Operators (MNO) and Application Service Providers (ASP) going forward, thereby enabling them to host their Edge applications close to the users. EDGEAPP is the 3GPP framework for enabling Edge Computing applications.

Turning now to FIG. 5B, the exemplary 3GPP EDGEAPP architecture 550 is illustrated. The architecture 550 illustrated in FIG. 5B is documented in further detail in 3GPP TS 23.558. The EDGEAPP architecture 550 comprises various components, including: an exemplary UE 552, the 3GPP core network 570, an Edge Data Network (EDN) 574, and an Edge Configuration Server (ECS) 586.

UE 552 may comprise various Application Clients (ACs) 554 that connect to an Edge Enabler Client (EEC) 558, e.g., via an EDGE-5 reference point (556). The EEC 558 may provide various support functions, such as Edge Application Server (EAS) discovery to the Application Clients 554 in the UE 552. EEC 558 may connect to an Edge Enabler Server (EES) 578, e.g., via an EDGE-1 reference point (560) and may connect to an Edge Configuration Server (ECS) 586 via an EDGE-4 reference point (562). In the edge computing scenario, the UE 552 may communicate through the 3GPP core network 570 over the user plane 572, i.e., to send its application-level data traffic to the EDN 574. An EAS and EES are assumed to be co-located in the same Edge Hosting Environment (EHE) (wherein the EHE in EDGEAPP is functionally analogous to the MEC host in ETSI). The EHE, as used here, refers to a specific data center, whereas Edge Data Network (EDN) 574 is considered to be a network providing “edge” (i.e., more localized) specific end-user services. An EDN may also have a specific service area, i.e., users have to be within a certain location to access the services of the EDN. Therefore, there may also be multiple physical EHEs within a particular EDN.

Edge Data Network (EDN) 574 may comprise one or more EASs 576 and one or more Edge Enabler Servers (EES) 578. The EES 578 is primarily responsible for enabling discovery of the EASs 576. The ECS 586 may be used to provide various configurations to the EEC 558 to connect with an EES 578 that, in turn, enables discovery of EASs 576. The ECS 586 may also be connected to EES 578 via an EDGE-6 reference point (584). An EES may also have an interface to other EESs, e.g., via an EDGE-9 reference point (582). EAS 576 may connect to EES 578 via an EDGE-3 reference point (580).

The 3GPP core network 570 may: connect to ECS 586, e.g., via an EDGE-8 reference point (568); may connect to EES 578, e.g., via an EDGE-2 reference point (566); and may connect to an EAS 576 via an EDGE-7 reference point (564).

Application Clients 554 on the UE 552 can be “Edge-aware” and “Edge-unaware.” With Edge-aware applications, the Application Clients 554 get the full benefit of the EDGEAPP architecture by directly interacting with—and thus leveraging—all of the benefits of the EEC 558.

### MEC Application Instance Registration

In a MEC system, applications and their respective instances may be managed by the MEC system's own management and orchestration system (MEC MANO), e.g., element 510 in FIG. 5A, or they may be managed independently of the MEC MANO. In the context of MEC, applications managed through either route are referred to herein as “MEC apps” (e.g., element 528 in FIG. 5A). When a MEC app is instantiated at a particular MEC host (e.g., an edge node/edge hosting environment, such as element 512 in FIG. 5A), by the MEC MANO or otherwise, it is referred to herein as an “application instance” or a “MEC app instance.”

To support such application instances, MEC has defined a MEC platform (MEP) (e.g., element 518 in FIG. 5A) that offers a range of MEC services. These MEC services may be offered directly through the MEP, or through service producing application instances. The Mp1 reference point (as described above with reference to FIG. 5A, element 525) is defined between MEC app instances and the MEP, through which MEC app instances gain access to MEC services.

One capability offered through this Mp1 reference point is MEC app instance registration to the MEP. This enables MEC app instances to provide runtime information to the MEP. For an app instance not managed by the MEC MANO, there is currently no mechanism to cause the announcement of the instance registration to the MEC system (whereas MEC MANO-managed applications will already be known to the MEC system) and/or enable its discovery (noting that the instance is expected to provide, among other attributes, its endpoint information, e.g., IP address, FQDN, URI). Such discovery may be intra-MEC system, or it may be inter-MEC system (e.g., discovery across a federation of MEC systems).

As described above with reference to FIG. 5B, the 3GPP Working Group 6 (WG6), in 3GPP TS 23.558, has defined an architecture for the enablement of edge applications (EDGEAPP), which is another MEC-like system. EDGEAPP defines the concept of an Edge Application Server (EAS), e.g., element 576 in FIG. 5B, which has an equivalence to a MEC app. EDGEAPP does not assume EAS instances to be managed by the MEC system. However, both ETSI MEC and 3GPP WG6 have considered a harmonized architecture, wherein an EAS could utilize the aforementioned Mp1 reference point. Therefore, an EAS in EDGEAPP can be considered as another example of a non-MEC MANO-managed application instance.

The current MEC AppInfo data type includes a Boolean attribute called: “isInsByMec.” That attribute is set to true for a MEC MANO-managed MEC app. The MEC AppInfo data can also provide an AppProfile attribute (which maps to the EAS Profile in the 3GPP-specified EDGEAPP), which provides a range of EAS-related attributes, e.g., EASID and the EAS endpoint. The AppInfo may also include services required by the application instance and services optional to the application instance, which may influence the decision on whether the application instance is able to successfully register to the MEP.

The process of MEC application instance registration to a MEC platform (MEP) has been defined in ETSI GS MEC 011. As part of MEC application instance registration process, the instance provides runtime information encapsulated in the AppInfo data type (including attributes such as an application name, or “appName”). The AppInfo is stored in an instance-specific resource accessible through the MEP, which can be identified through the app instance identifier, e.g.: /registrations/{appInstanceId}. In EDGEAPP, the EASRegistration data type is used in place of AppInfo.

For MEC MANO-managed instances, that appInstanceId is assigned during the instantiation procedures (as defined in ETSI GS MEC 010-2). For instances not managed by the MEC MANO, the current ETSI specification states that the appInstanceId is provided to the instance in the registration response. Thus, as mentioned above, this disclosure provides solutions to the problem of how to make the MEC MANO aware of a “non-MEC MANO-managed” application instance when such an instance makes a registration request, and it also addresses the assignment of the appInstanceId. Such solutions will enable inter-MEC system application instance discovery. Such discovery processes may also enable the sharing of the application info data type (e.g., the AppInfo data type) —although access to certain attributes of certain data types may still potentially be restricted, e.g., based on permission levels and/or the MEC system's service provider policy.

### MEC Application Instance Registration

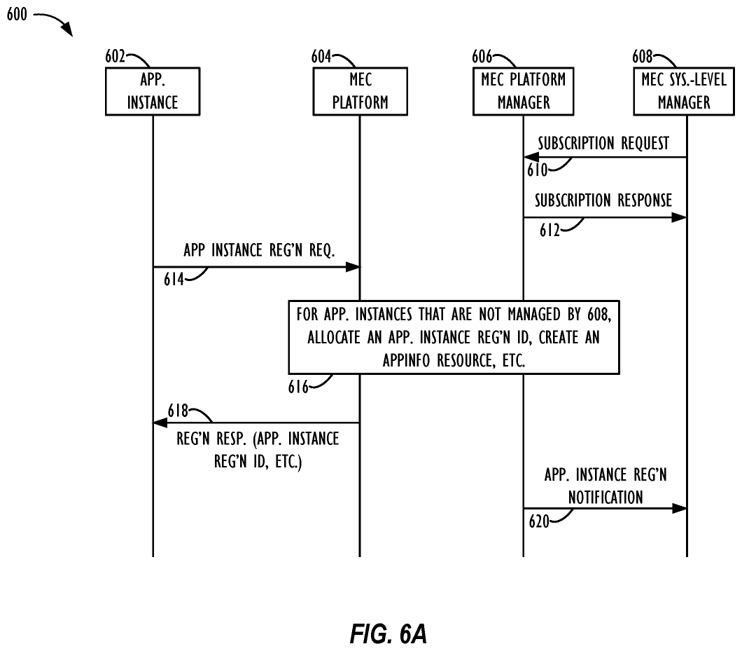

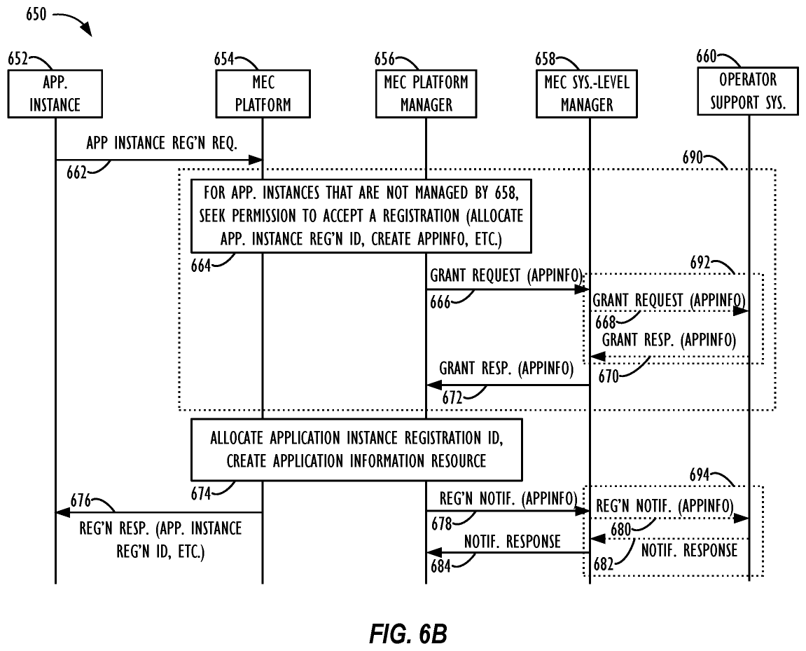

Turning now to FIG. 6A, a diagram 600 detailing a method of MEC application instance registration is illustrated, according to some aspects. In the example of diagram 600, it is assumed that the application instance 602 is pre-authorized to communicate with the MEC Platform 604 and is aware of its address, e.g., in the form of a Universal Resource Identifier (URI). The MEC system-level manager 608 in FIG. 6A may be analogized, e.g., to the MEC Orchestrator 510 of FIG. 5A, but could comprise any device(s) providing MEC system-level management.

First, at step 614, an application instance 602 may send an application instance registration request to the MEC platform 604. Then, at step 616, for application instances that are not managed by MEC system-level manager 608 (i.e., the so-called “non-MEC MANO-managed” application instances), the MEC platform (MEP) 604 and/or MEC platform manager (MEPM) 606 may allocate an application instance registration identifier, and then create an AppInfo resource for the application instance 602. In 3GPP EDGEAPP, the application instance registration identifier may be referred to as “registrationId,” whereas, in MEC, the application instance registration identifier may be referred to as the “appInstanceId” (e.g., as allocated by the MEPM). Both identifiers should be unique within at least the scope of the MEPM (in the case of ETSI)/EES (in the case of EDGEAPP) and may be assigned to ensure uniqueness across the whole MEC system (or to be globally unique). At Step 618, the MEC platform 604 may return a registration response to the application instance 602, including the created AppInfo resource and the newly allocated application instance registration identifier.

In some implementations, at step 610, the MEC system-level manager 608 may independently indicate a desire to MEC platform manager 606 to be notified of any new application instance registrations. At step 612, MEC platform manager 606 may provide a subscription response to MEC system-level manager 608, e.g., indicating that the subscription has been activated. Then, after the registration of a new application instance (e.g., as described above with reference to step 616), MEC platform manager 606 may, at Step 620, send a notification to the MEC system-level manager 608 informing it that the application instance 602 has indeed been successfully registered. This notification may include at least the aforementioned application instance registration identifier, but potentially the full AppInfo record as well.

According to some implementations, the ETSI “STARTED” application instance operational state may be reused or, alternately, a new operational state (e.g., “REGISTERED”) may be created to enable the MEC system-level manager 608 (e.g., a MEC Orchestrator, or other entities/consumers) to subscribe to the MEC platform manager 606 (e.g., over the Mm3 reference point) for notifications of application registrations—in particular, notifications of non-MEC MANO-managed application instances (but not limited thusly).

For example, Table 6.2.2.10.2-1 of ETSI GS MEC 010-2 may be modified to include new appInstanceStates, such as: “REGISTERED” (i.e., the application instance has registered to the MEC Platform); “DE-REGISTERED” (i.e., the application instance has de-registered from the MEC Platform); and “REGISTRATION_UPDATE” (i.e., the application instance has updated its registration to the MEC Platform).

At a minimum, the associated notifications should include the appInstanceId assigned by the MEP/MEPM, but they could also include the whole AppInfo. A procedure to allow the MEC system-level management device (e.g., MEC Orchestrator (MEO) or other authorized entity) to query the MEP/MEPM for the AppInfo, or specific attributes from within the AppInfo according to permissions granted to the querying entity and the MEC system service provider policy should be provided, e.g., via re-use of the existing ETSI GS MEC 011 query procedure (GET/registrations/{appInstanceId}) between the MEO and MEP/MEPM (i.e., rather than simply between MEC app instance and MEP).

Such a notification could also be used by the MEC MANO to maintain the ETSI GS MEC 010-2 /{appInstanceId} resource containing the AppInstanceInfo data type. The notification could also be used by the could also be used by the MEC MANO to deploy or instantiate services according to the application instance requirements contained in the AppInfo. The subscription request could also include an indication of whether the MEC MANO/MEO wished to be informed about registrations, de-registrations, or registration updates. Alternatively, as described above, a dedicated subscription (with notification) procedure could be defined for application registration (but with similar information exchanged for application instance registration subscription and associated notification).

According to some other implementations, the AppInstanceSubscriptionFilter of Table 6.2.2.5.2-1 of ETSI GS MEC 010-2 could be updated, or another attribute could be added to AppInstSubscriptionInfo to indicate only “non-MEC MANO-registered” applications are of interest (i.e., since the other attributes are less likely to be known a priori, they are not seen as likely to be relevant in the case of a non MEC MANO managed application instance). However, it still may be of interest to a general consumer of the notifications to utilize some or all of the other filters. In ETSI GS MEC 010-2, there is also the AppLcmOpOccSubscriptionRequest (i.e., the application lifecycle operation occurrence subscription procedure) that could be re-used for this purpose, if desired.

Turning now to Table 6.2.2.11.2-1 of ETSI GS MEC 010-2, some attributes of the existing AppInstNotification may not be relevant for “non-MEC MANO-managed” application instances, e.g., appPkgId and appDId (e.g., as those attributes come from the application package on-boarded through the MEC MANO), and thus they may be changed to be “optional” attributes. Further, the AppInfo field could be added as an optional attribute to store the application information provided by a MEC application instance at registration, and it also conveniently already includes an attributed relating to whether the application is MEC MANO managed or not (i.e., isInsByMec).

It is to be understood that the techniques described in FIG. 6A may be equally applicable to the ETSI MEC environment and the 3GPP EDGEAPP environment, with analogous system components performing the functionality as described by the components illustrated in FIG. 6A. For example, in EDGEAPP, there will also be an orchestrator/system-level management device, but it may be an ETSI Network Functions Virtualization (NFV) specified orchestrator (i.e., NFVO). There is also a MEC architectural variant that merges the MEC and NFV architecture, therefore, an enhanced NFV orchestrator may also be used by MEC. For further examples: the role of the MEP in EDGEAPP may be performed by the EES; and the role of the MEPM may be performed by the NFV Virtualized Network Function Manager (VNFM).

MEC Application Instance Registration with Grant Notification

Turning now to FIG. 6B, a diagram 650 detailing a method of MEC application instance registration that includes a granting procedure in order to allow an application instance to successfully register is illustrated, according to some aspects. In the example of diagram 650, it is assumed that the application instance 652 is pre-authorized to communicate with the MEC Platform 654 and is aware of its address, e.g., URI, and that MEP 654/MEPM 656 knows the MEC system-level manager 658 endpoint, e.g., IP address or URI. The MEC system-level manager 658 in FIG. 6B may again be analogized, e.g., to the MEC Orchestrator 510 of FIG. 5A, but could comprise any device(s) providing MEC system-level management.

First, at step 662, an application instance 652 may send an application instance registration request to the MEC platform 654. Then, at step 664, for application instances that are not managed by MEC system-level manager 658 (i.e., the so-called “non-MEC MANO-managed” application instances), the MEC platform (MEP) 654 and/or MEC platform manager (MEPM) 656 may seek permission to allocate an application instance registration identifier. According to some aspects, there may be a check to see whether the application instance has the appropriate authorization to register to the MEP 654 and then a further check to decide whether the application is permitted to register at this particular instance (e.g., at this particular time, date, etc.). According to other aspects, a MEC system-level “policy” may be used to influence the permission-seeking behavior of the system, e.g., defining whether the MEP 654/MEPM 656 is required to request registration permission from the MEC system-level manager 658 (and, further, whether the MEC system-level manager 658 has to request permission from the OSS 660).

As shown within dashed line box 690, the process of seeking permission, according to some aspects, may include, at step 666, sending a grant request from the MEPM 656 (e.g., including the Application Info resource) to the MEC system-level manager 658 (e.g., an MEO), and then receiving a grant response from the MEC system-level manager 658 at step 672, indicating that the application instance registration may be accepted by MEP 654. According to some aspects, as part of the grant request procedure at step 666, a check can be performed by the MEC system-level manager 658 to see if the application instance is already registered in the MEC system (and the registration request may be denied if the application instance is found to already be registered in the MEC system). According to still other aspects, as shown within dashed line box 692, the MEC system-level manager 658 itself may be required to send the grant request, at step 668, to an operator support system 660 (e.g., the aforementioned OSS and/or BSS entities), and then receive a grant response from the operator support system 660 at step 670, before finally returning the grant response to the MEPM 656 at step 672. The decision to accept the grant request may be influenced by the information provided in the grant request (e.g., the Application Info resource information) and, in particular, the application instance requirements for certain services or features. Such requirements may trigger the MEC system-level manager 658 to deploy or instantiate services or features according to the application instance's requirements.

Once permission has been granted (e.g., by 658 and/or 660), at Step 674, MEP 654/MEPM 656 may allocate an application instance registration identifier and then create an AppInfo resource for the application instance 652. According to some aspects, it may actually be preferable for the application instance registration identifier to be allocated by the MEC platform device 654 before the MEC platform device 654 causes the permission request to be sent to the MEC system-level management device 658 at step 666. At Step 676, the MEC platform 654 may return a registration response to the application instance 652, including the created AppInfo resource, which may also include the newly allocated application instance registration identifier.

In some implementations, at step 678, the MEC platform manager 656 may, at step 678 provide a registration notification (e.g., including the Application Info resource) to MEC system-level manager 658 informing it that the application instance 652 has indeed been successfully registered. MEC system-level manager 658 may, at step 684, provide a notification response that the registration notification has been successfully received. According to still other aspects, as shown within dashed line box 694, the MEC system-level manager 658 itself may be required to send the registration notification, at step 680, to the operator support system 660, and then receive a notification response from the operator support system 660 at step 682, before finally returning the notification response to the MEPM 656 at step 684. According to some aspects, the notification resulting from an application instance registration (e.g., at step 678) may be captured as another system trigger. For example, an application instance (e.g., 652) might successfully become registered, but it still may not yet be able to provide services or features to its consumers until such services or features are made available at the MEC platform 654. Or, in the case that the required services or features are already available, then the application instance (e.g., 652) can begin to offer the services or features to its consumers, but it could also potentially offer enhanced services or features at a later time, e.g., if the optional services or features (i.e., services or features that weren't necessarily available at the time of registration) were subsequently made available to it.

As may now be appreciated, according to some aspects (e.g., as shown in FIG. 6B), a granting procedure may be required to allow an application instance to successfully register to a MEP. As described above with reference to diagram 650, when an application instance makes a registration request, the MEP 654/MEPM 656 could initiate a procedure towards the MEC system-level manager (e.g., MANO) 658, seeking granting permission for registration. Preferably, the AppInfo should be included in the grant request, providing all the relevant information for subsequent discovery of the MEC application instance. (This may be particularly relevant for inter-MEC system/federation scenarios.)

As summarized above, the MEP 654/MEPM 656 could assign the application instance registration identifier before requesting the grant, or it could wait until the grant is received. The MEC system-level manager 658 may itself be authorized to grant permission, or it may have to seek further permission from the operator support system 660.

If a priori permission for application instance registration is not required, the MEP 654/MEPM 656 could simply notify the MEC system-level manager (e.g., MANO, MEO, etc.) 658 and return a registration response to the application instance 652. However, if permission is required, all the relevant application info (e.g., AppInfo) may have already been passed to the MEC system-level manager 658 in the grant exchange. However, if it has not all been passed, then the notification procedure (e.g., as shown at Steps 678/684 and in dashed line box 694) could be used to exchange any remaining AppInfo (i.e., the minimum amount of necessary AppInfo could be exchanged in the initial grant request, and then remainder could be shared via the notification registration).

### Exemplary Methods

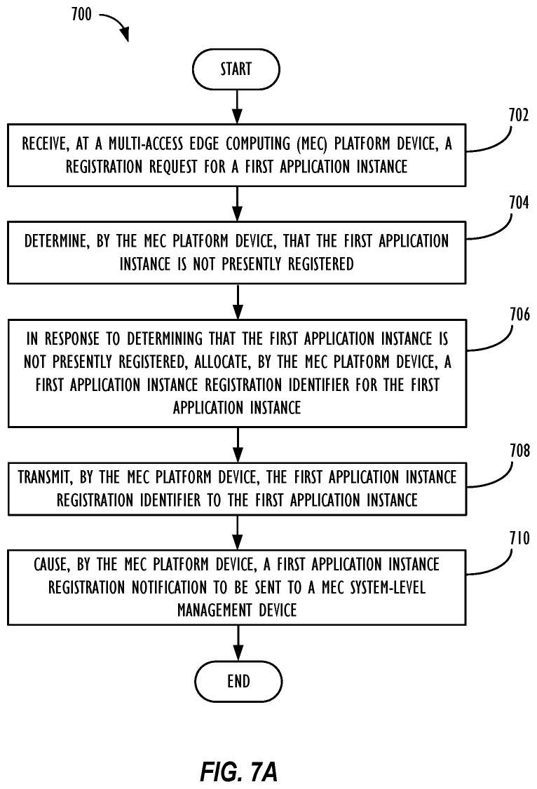

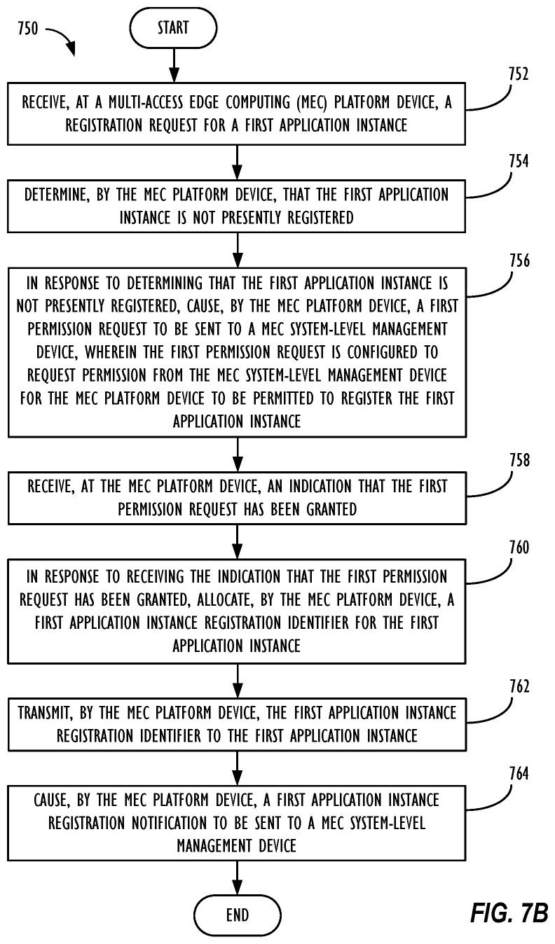

Turning now to FIG. 7A, a flowchart detailing a method 700 of performing MEC application instance registration is shown, according to some aspects. First, at block 702, the method of 700 may receive, at a MEC platform device, a registration request for a first application instance. Next, at block 704, the method 700 may determine, by the MEC platform device, that the first application instance is not presently registered. Next, at block 706, the method 700 may, in response to determining that the first application instance is not presently registered, allocate, by the MEC platform device, a first application instance registration identifier for the first application instance.

Next, at block 708, the method 700 may, transmit, by the MEC platform device, the first application instance registration identifier to the first application instance. Finally, at block 710, the method 700 may cause, by the MEC platform device, a first application instance registration notification to be sent to a MEC system-level management device.

Turning now to FIG. 7B, a flowchart detailing a method 750 of performing MEC application instance registration that includes a granting procedure in order to allow an application instance to successfully register is shown, according to some aspects. First, at block 752, the method of 750 may receive, at a MEC platform device, a registration request for a first application instance. Next, at block 754, the method 740 may determine, by the MEC platform device, that the first application instance is not presently registered.

Next, at block 756, the method 750 may, in response to determining that the first application instance is not presently registered, cause, by the MEC platform device, a first permission request to be sent to a MEC system-level management device, wherein the first permission request is configured to request permission from the MEC system-level management device for the MEC platform device to be permitted to register the first application instance.

Next, at block 758, the method 750 may, receive, at the MEC platform device, an indication that the first permission request has been granted. In response to receiving the indication that the first permission request has been granted, at block 760, the method 750 may allocate, by the MEC platform device, a first application instance registration identifier for the first application instance.

Next, at block 758, the method 700 may, transmit, by the MEC platform device, the first application instance registration identifier to the first application instance. Finally, at block 760, the method 700 may cause, by the MEC platform device, a first application instance registration notification to be sent to a MEC system-level management device.

### Additional Comments

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a non-transitory memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method of application instance registration in a Multi-access Edge Computing (MEC) system, the method comprising:
receiving, at a MEC platform device, a registration request for a first application instance;
determining, by the MEC platform device, that the first application instance is not presently registered;
in response to determining that the first application instance is not presently registered, allocating, by the MEC platform device, a first application instance registration identifier for the first application instance;
transmitting, by the MEC platform device, the first application instance registration identifier to the first application instance; and
causing, by the MEC platform device, a first application instance registration notification to be sent to a MEC system-level management device.

2. The method of claim 1, wherein the MEC platform device is communicatively coupled to a MEC platform manager device.

3. The method of claim 2, wherein the MEC platform device and MEC platform manager device are communicatively coupled via an interface.

4. The method of claim 3, wherein the interface comprises an Mm5 reference point.

5. The method of claim 1, wherein determining that the first application instance is not presently registered further comprises:
determining, by the MEC system-level management device, that the first application instance is not presently registered by the MEC system.

6. The method of claim 1, wherein the registration request for the first application instance comprises at least one identifier uniquely identifying the first application instance.

7. The method of claim 1, wherein determining that the first application instance is not presently registered further comprises:
determining that the first application instance is not presently registered by a management and orchestration (MANO) system of the MEC system.

8. The method of claim 1, wherein the first application instance registration notification comprises at least the first application instance registration identifier.

9. The method of claim 8, wherein the first application instance registration notification further comprises one or more additional application information fields associated with the first application instance.

10. A method of application instance registration in a Multi-access Edge Computing (MEC) system, the method comprising:
receiving, at a MEC platform device, a registration request for a first application instance;
determining, by the MEC platform device, that the first application instance is not presently registered;
in response to determining that the first application instance is not presently registered, causing, by the MEC platform device, a first permission request to be sent to a MEC system-level management device, wherein the first permission request is configured to request permission from the MEC system-level management device for the MEC platform device to be permitted to register the first application instance;
receiving, at the MEC platform device, an indication that the first permission request has been granted;
in response to receiving the indication that the first permission request has been granted, allocating, by the MEC platform device, a first application instance registration identifier for the first application instance;
transmitting, by the MEC platform device, the first application instance registration identifier to the first application instance; and
causing, by the MEC platform device, a first application instance registration notification to be sent to the MEC system-level management device.

11. The method of claim 10, wherein the MEC platform device is communicatively coupled to a MEC platform manager device.

12. The method of claim 10, wherein determining that the first application instance is not presently registered further comprises:
determining, by the MEC system-level management device, that the first application instance is not presently registered by the MEC system.

13. The method of claim 10, wherein the registration request for the first application instance comprises at least one identifier uniquely identifying the first application instance.

14. The method of claim 10, further comprising:
causing the first permission request to be sent from the MEC system-level management device to an operator-level support device of the MEC system,
wherein the MEC system-level management device is further configured to request permission from the operator-level support device for the MEC platform device to be permitted to register the first application instance.

15. The method of claim 10, wherein the first application instance registration notification comprises at least the first application instance registration identifier.

16. The method of claim 15, wherein the first application instance registration notification further comprises one or more additional application information fields associated with the first application instance.

17. The method of claim 10, wherein the first application instance registration notification is further caused to be sent to an operator-level support device.

18. The method of claim 10, wherein the first application instance registration identifier is allocated by the MEC platform device before the MEC platform device causes the first permission request to be sent to the MEC system-level management device.

19. The method of claim 10, wherein the requesting of permission from the MEC system-level management device for the MEC platform device to be permitted to register the first application instance further comprises:
causing, at the MEC system-level management device, any services or features required by the first application instance to be made available at the MEC platform device.

20. A device comprising: a receiver; a transmitter; at least one interface; and a processor configured to perform the method of claim 1.
